(19) United States
(12) Patent Application Publication
(10) Pub. No.: US 2025/0028274 A1
(43) Pub. Date: Jan. 23, 2025

(54) TRANSPORT DEVICE AND IMAGE FORMING APPARATUS

(71) Applicant: FUJIFILM Business Innovation Corp., Tokyo (JP)

(72) Inventors: Kohei IKENAGA, Yokohama-shi (JP); Tatsuro MATSUOKA, Yokohama-shi (JP)

(73) Assignee: FUJIFILM Business Innovation Corp., Tokyo (JP)

(21) Appl. No.: 18/432,850

(22) Filed: Feb. 5, 2024

(30) Foreign Application Priority Data
Jul. 21, 2023 (JP) 2023-119395

(51) Int. Cl. G03G 15/00

(52) U.S. Cl. CPC G03G 15/6558; G03G 15/6529; G03G 2215/00675

(57) ABSTRACT

A transport device includes a transport roll that rotates and that transports a recording medium by pinching the recording medium in a transport region from one end to the other end in an axial direction and a guide member that guides a leading end of the recording medium to the transport roll by coming into contact with the recording medium while bending the recording medium and that is recessed such that a facing edge facing the transport region, among edges on a transport roll side, is separated from the transport roll compared to side edges arranged respectively on both sides of the facing edge.

### CROSS-REFERENCE TO RELATED APPLICATIONS

This application is based on and claims priority under 35 USC 119 from Japanese Patent Application No. 2023-119395 filed Jul. 21, 2023.

### BACKGROUND

### (i) Technical Field

The present invention relates to a transport device and an image forming apparatus.

### (ii) Related Art

A paper transport device described in JP2016-50096A is a paper transport device that is provided with a bent transport path from a merging portion where a plurality of transport paths consisting of transport guides which transport paper merge to a downstream side in a paper transport direction and that includes a paper guide member which is extended from the transport guide positioned at a central portion of the merging portion toward the bent transport path in the merging portion, in which the extended portion of the paper guide member is arranged in a non-contact with respect to another transport guide in the merging portion.

### SUMMARY

There is a guide member that guides a leading end of a recording medium to a transport roll by coming into contact with the recording medium and changing a transport direction of the recording medium while bending the recording medium. An edge of the guide member on a transport roll side extends linearly along an axial direction of the transport roll over the whole guide member.

In such a configuration, in a case where a trailing end of the recording medium bent by being guided by the guide member passes through the edge of the guide member, rising sound is generated in some cases as a trailing end portion of the recording medium rises.

Aspects of non-limiting embodiments of the present disclosure relate to a transport device and an image forming apparatus that compared to a case where an edge of a guide member, which guides a recording medium while bending the recording medium, on a transport roll side extends linearly along an axial direction of a transport roll over the whole guide member, suppress rising sound generated in a case where a trailing end of the recording medium passes through the edge of the guide member with a transport performance of the recording medium maintained.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a transport device including a transport roll that rotates and that transports a recording medium by pinching the recording medium in a transport region from one end to the other end in an axial direction and a guide member that guides a leading end of the recording medium to the transport roll by coming into contact with the recording medium while bending the recording medium and that is recessed such that a facing edge facing the transport region, among edges on a transport roll side, is separated from the transport roll compared to side edges arranged respectively on both sides of the facing edge.

### BRIEF DESCRIPTION OF THE DRAWINGS

Exemplary embodiment(s) of the present invention will be described in detail based on the following figures, wherein:

FIG. 1 is a schematic configuration view showing an image forming apparatus according to an exemplary embodiment of the present disclosure;

FIG. 2 is a schematic configuration view showing a toner image forming unit of the image forming apparatus according to the exemplary embodiment of the present disclosure;

FIGS. 3A and 3B are schematic configuration views showing a transport unit according to the exemplary embodiment of the present disclosure;

FIG. 4 is a view showing a guide member or the like included in the transport unit according to the exemplary embodiment of the present disclosure;

FIGS. 5A to 5C are step views showing steps of transporting a sheet member in the transport unit according to the exemplary embodiment of the present disclosure;

FIG. 6 is a view showing a guide member or the like included in a transport unit according to a comparative embodiment of the exemplary embodiment of the present disclosure; and

FIGS. 7A to 7C are step views showing steps of transporting a sheet member in the transport unit according to the comparative embodiment of the exemplary embodiment of the present disclosure.

### DETAILED DESCRIPTION

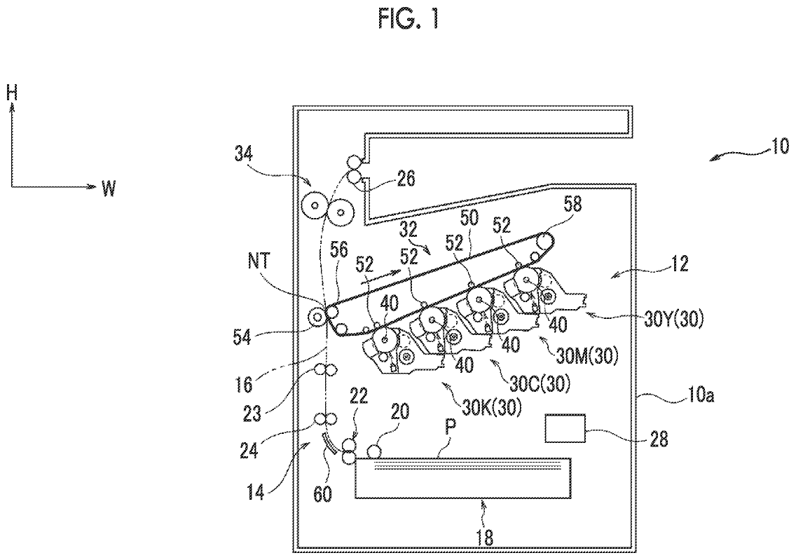

An example of a transport unit and an image forming apparatus according to an exemplary embodiment of the present disclosure will be described with reference to FIGS. 1 to 7C. An arrow H shown in each drawing indicates an apparatus up-down direction, which is a vertical direction, an arrow W indicates an apparatus width direction, which is a horizontal direction, and an arrow D indicates an apparatus depth direction, which is a horizontal direction.

### Overall Configuration of Image Forming Apparatus 10

As shown in FIG. 1, an image forming apparatus 10 includes an image forming unit 12 that forms a toner image through an electrophotographic method and a transport unit 14 that transports a sheet member P, which is a recording medium, along a transport path 16. In addition, the image forming apparatus 10 includes an accommodating member 18 that accommodates the sheet member P and a control unit 28 that controls the entire apparatus.

In the image forming apparatus 10, the sheet member P accommodated in the accommodating member 18 is transported along the transport path 16 by the transport unit 14. Further, a toner image formed by the image forming unit 12 is formed on the transported sheet member P, and the sheet member P on which the toner image is formed is discharged to the outside of an apparatus body 10a.

### Image Forming Unit 12

As shown in FIG. 1, the image forming unit 12 includes a plurality of toner image forming units 30 that form toner images of respective colors and a transfer unit 32 that transfers the toner images formed by the toner image forming units 30 to the sheet member P. Further, the image forming unit 12 includes a fixing device 34 that fixes the toner images, which are transferred to the sheet member P by the transfer unit 32, to the sheet member P.

### Toner Image Forming Unit 30

The plurality of toner image forming units 30 are provided to form a toner image for each color. In the present exemplary embodiment, in total, four colors of yellow (Y), magenta (M), cyan (C), and black (K) toner image forming units 30Y, 30M, 30C, and 30K are provided. In the following description, in a case where it is not necessary to distinguish between yellow (Y), magenta (M), cyan (C), and black (K), Y, M, C, and K attached to the reference numerals are omitted.

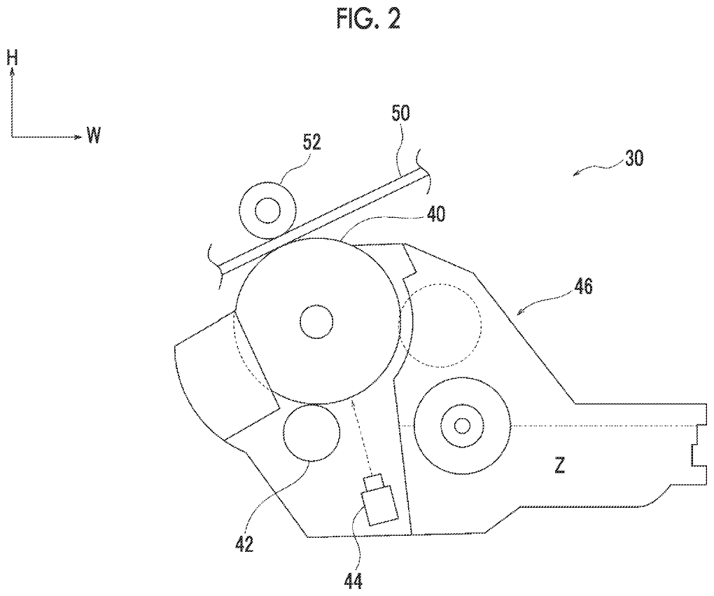

The toner image forming unit 30 of each color is basically configured in the same manner except for a toner to be used and, as shown in FIG. 2, includes a rotating cylindrical image holding body 40 and a charger 42 that charges the image holding body 40. Further, the toner image forming unit 30 includes an exposure device 44 that irradiates the charged image holding body 40 with exposure light to form an electrostatic latent image and a developing device 46 that develops the electrostatic latent image with a developer Z containing a toner as a toner image. Accordingly, the toner image forming unit 30 of each color forms an image of each color using a toner of each color.

In addition, as shown in FIG. 1, the image holding body 40 of each color is in contact with a transfer belt 50 (details to be described later) that moves around. In a circumferential direction (see an arrow in FIG. 1) of the transfer belt 50, the yellow (Y), magenta (M), cyan (C), and black (K) toner image forming units 30 are arranged side by side in turn from an upstream side.

### Transfer Unit 32

As shown in FIG. 1, the transfer unit 32 includes the transfer belt 50 and primary transfer rolls 52 each of which is arranged on an opposite side of the image holding body 40 of each color with the transfer belt 50 pinched therebetween and transfers a toner image formed on the image holding body 40 of each color to the transfer belt 50.

Further, the transfer unit 32 includes a winding roll 56 around which the transfer belt 50 is wound, a drive roll 58 around which the transfer belt 50 is wound and which transmits a rotational force to the transfer belt 50, and a secondary transfer roll 54 which is arranged on an opposite side of the winding roll 56 with the transfer belt 50 pinched and which transfers a toner image transferred to the transfer belt 50 to the sheet member P. A transfer nip NT where the toner image is transferred to the sheet member P is formed between the secondary transfer roll 54 and the transfer belt 50.

### Fixing Device 34

As shown in FIG. 1, the fixing device 34 is arranged on a downstream side of the transfer nip NT in a transport direction of the sheet member P. The fixing device 34 heats and pressurizes a toner image transferred to the sheet member P to fix the toner image to the sheet member P.

### Transport Unit 14

As shown in FIG. 1, the transport unit 14 transports the sheet member P and discharges the sheet member P on which an image is formed to the outside of the apparatus body 10a. Details of the transport unit 14 will be described later.

### Major Portion Configuration

Next, the transport unit 14 will be described. The transport unit 14 is an example of a transport device.

As shown in FIG. 1, the transport unit 14 includes a feeding roll 20 that feeds the sheet member P accommodated in the accommodating member 18 to the transport path 16 and a prevention roll 22 that prevents double-feeding of the sheet member P fed by the feeding roll 20. Further, the transport unit 14 includes a transport roll 23 that feeds the sheet member P to the transfer nip NT and a discharge roll 26 that discharges the sheet member P on which a toner image is fixed by the fixing device 34 to the outside of the apparatus body 10a.

In addition, the transport unit 14 includes a transport roll 24 that feeds the sheet member P to the transport roll 23 and a guide member 60 that guides a leading end of the sheet member P to the transport roll 24 by coming into contact with the sheet member P while bending the sheet member P fed from the prevention roll 22.

### Prevention Roll 22

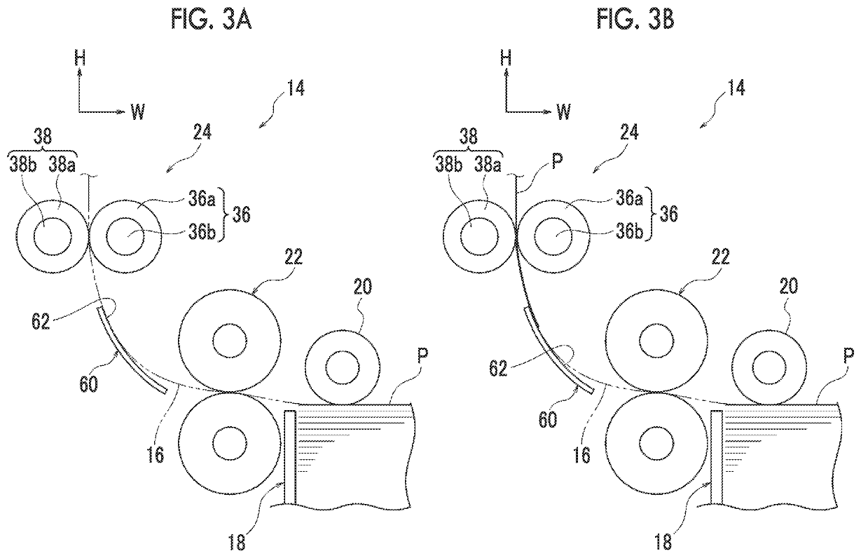

As shown in FIGS. 3A and 3B, the prevention roll 22 is arranged on the downstream side of the feeding roll 20 in the transport direction of the sheet members P (hereinafter, referred to as a “sheet transport direction”). The prevention roll 22 transports the sheet member P in the apparatus width direction.

### Transport Roll 24

As shown in FIGS. 3A and 3B, the transport roll 24 is arranged on the downstream side of the prevention roll 22 in the sheet transport direction. The transport roll 24 is configured to include a pair of rolls 36 and 38.

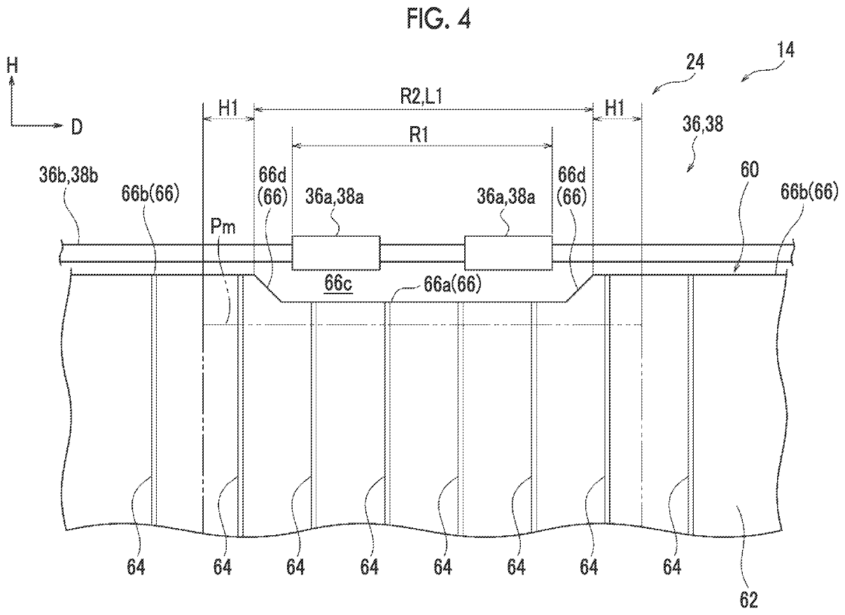

The roll 36 is configured to include a roll portion 36a that is formed in a cylindrical shape by an elastic material and a shaft member 36b that is inserted into the roll portion 36a and that formed is a cylindrical shape by a metal material. In addition, as shown in FIG. 4, two roll portions 36a are provided at an interval in an apparatus depth direction.

As shown in FIGS. 3A and 3B, the roll 38 is arranged on one side (a left side in FIGS. 3A and 3B) in the apparatus width direction with respect to the roll 36 and is configured to include a roll portion 38a that is formed in a cylindrical shape by an elastic material and a shaft member 38b that is inserted into the roll portion 38a and that is formed in a cylindrical shape by a metal material. In addition, as shown in FIG. 4, two roll portions 38a are provided at an interval in the apparatus depth direction. In a case of being viewed from the apparatus width direction, the roll 38 overlaps the roll 36. Accordingly, the transport roll 24 transports the sheet member P in the apparatus up-down direction as the roll 38 is rotationally driven.

In addition, as shown in FIG. 4, a region from an outer end (one end) of one of the roll portion 36a or 38a to an outer end (the other end) of the other one of the roll portion 36a or 38a in the apparatus depth direction that is an axial direction of the transport roll 24 is a transport region R1 where the sheet member P is pinched and a transport force is transmitted to the sheet member P.

### Guide Member 60

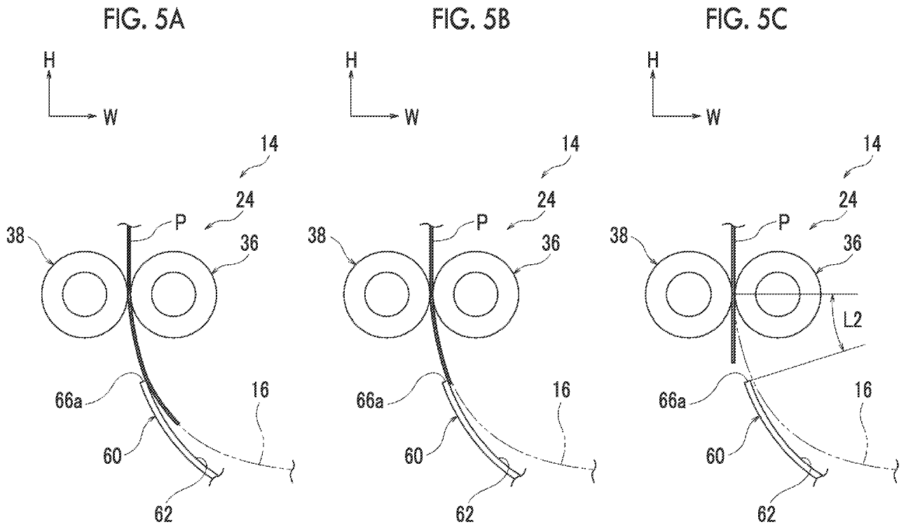

As shown in FIGS. 3A and 3B, the guide member 60 is arranged between the prevention roll 22 and the transport roll 24 in the sheet transport direction, and a guide surface 62 that guides the sheet member P and a plurality of ribs 64 (see FIG. 4) that are formed on the guide surface 62 are formed at the guide member 60. The ribs 64 are omitted in FIGS. 3A and 3B and FIGS. 5A to 5C.

The guide surface 62 has a bent shape, and on the guide surface 62, as shown in FIG. 4, the ribs 64 extending in the sheet transport direction are formed at intervals in the apparatus depth direction. The height of the rib 64 is, for example, 1 [mm].

In addition, edges 66 that separate the guide member 60 on a transport roll 24 side from the transport roll 24 in the sheet transport direction are formed. In addition, of the edges 66, a facing edge 66a that faces the transport region R1 in the sheet transport direction is recessed to be separated from the transport roll 24 compared to side edges 66b arranged respectively on both sides of the facing edge 66a. Accordingly, a recessed portion 66c is formed in the guide member 60.

Specifically, the facing edge 66a and the side edges 66b extend linearly in the apparatus depth direction. In addition, connecting edges 66d that connect the facing edge 66a and the side edges 66b to each other are formed as the edges 66. Further, the connecting edges 66d are inclined with respect to the sheet transport direction such that an opening width (R2 in FIG. 4) of the recessed portion 66c is wider than the facing edge 66a in the apparatus depth direction.

In addition, a separation distance L1 between one side edge 66b and the other side edge 66b is shorter than the width of the sheet member P having a minimum size (“sheet member Pm” shown in FIG. 4) that can be transported by the transport unit 14. Further, at least some ribs 64 are formed in a range (H1 in FIG. 4) where the side edges 66b at portions through which the sheet member P having a minimum size passes are arranged in the apparatus depth direction. Herein, the sheet member P having a minimum size is described in description or the like of the transport unit 14 or the image forming apparatus 10.

### Action

Next, the action of the transport unit 14 will be described while comparing to a transport unit 114 according to a comparative embodiment. First, a configuration of the transport unit 114 according to the comparative embodiment will be described. A portion of the transport unit 114 different from the transport unit 14 according to the present exemplary embodiment will be generally described.

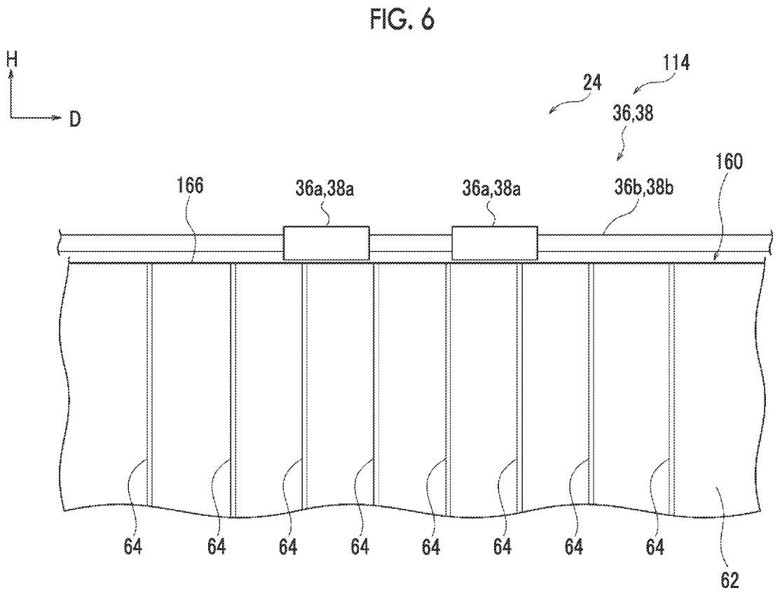

As shown in FIG. 6, an edge 166 facing the transport roll 24 in the sheet transport direction is formed on the transport roll 24 side of a guide member 160 included in the transport unit 114. The edge 166 extends linearly in the apparatus depth direction. The edge 166 overlaps the side edges 66b of the guide member 60 according to the present exemplary embodiment. In other words, the side edges 66b of the guide member 60 overlap the edge 166 of the guide member 160.

First, action of the transport unit 114 will be described. The guide member 160 guides the leading end of the sheet member P to the transport roll 24 while bending the sheet member P fed from the prevention roll 22 (see FIG. 1).

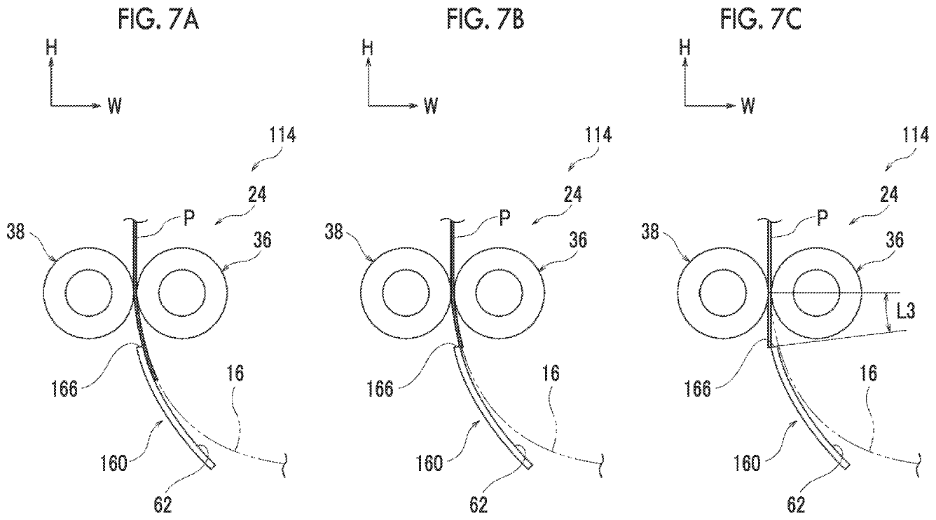

A portion of the sheet member P that is pinched and transported by the transport roll 24 on the upstream side in the sheet transport direction with respect to the transport roll 24 is pressed against a guide surface 62 side of the guide member 160 as shown in FIGS. 7A to 7C. Then, in a case where a trailing end of the sheet member P reaches the edge 166 of the guide member 160, the trailing end of the sheet member P is separated from the edge 166 of the guide member 160.

Herein, the guide member 160 changes the transport direction of the sheet member P by bending the sheet member P. For this reason, in a case where a portion of the trailing end of the sheet member P, which is pinched by the transport roll 24 in the apparatus depth direction, is separated from the edge 166 of the guide member 160, as shown in FIGS. 7B and 7C, the trailing end portion of the bent sheet member P extends and rises in the vertical direction. As the trailing end portion of the sheet member P rises in this manner, rising sound is generated. Herein, the rising sound is sound generated in a case where a bent portion of the sheet member P rises in a case where the sheet member P bent in a state of being viewed from the width direction is linear, and the rising sound is particularly large in a case of using thick paper as the sheet member P.

Next, action of the transport unit 14 according to the present exemplary embodiment will be described. The guide member 60 guides the leading end of the sheet member P to the transport roll 24 while bending the sheet member P fed from the prevention roll 22 (see FIG. 1).

A portion of the sheet member P that is pinched and transported by the transport roll 24 on the upstream side in the sheet transport direction with respect to the transport roll 24 is pressed against the guide surface 62 side of the guide member 60 as shown in FIGS. 5A to 5C. Then, in a case where the trailing end of the sheet member P reaches the facing edge 66a of the guide member 60, the trailing end of the sheet member P is separated from the facing edge 66a of the guide member 60.

Herein, in a case where the trailing end of the sheet member P, which is pinched by the transport roll 24 in the apparatus depth direction, is separated from the facing edge 66a of the guide member 60 (see FIGS. 5B and 5C), the trailing end portion of the bent sheet member P extends and rises in the vertical direction. As the trailing end portion of the sheet member P rises, rising sound is generated. However, a distance (L2 of FIG. 5C) between a pinched portion of the transport roll 24 where the sheet member P is pinched and the facing edge 66a of the guide member 60 is longer than a distance (a distance L3 of FIG. 7C) between the pinched portion of the transport roll 24 and the edge 166 of the guide member 160.

For this reason, a pressing force at which the trailing end portion of the sheet member P presses the guide surface 62 of the guide member 60 in a case where the trailing end of the sheet member P and the guide member 60 are separated from each other is weaker than a pressing force at which the trailing end portion of the sheet member P presses the guide surface 62 of the guide member 160 in a case where the trailing end of the sheet member P is separated from the guide member 160. Accordingly, rising sound generated in a case where the trailing end of the sheet member P is separated from the guide member 60 is smaller than rising sound generated in a case where the trailing end of the sheet member P is separated from the guide member 160.

In addition, the separation distance L1 between the one side edge 66b and the other side edge 66b is shorter than the width of the sheet member Pm having a minimum size that can be transported by the transport unit 14 (see FIG. 4). For this reason, a transport performance of the guide member 60 guiding the sheet member P fed from the prevention roll 22 to the transport roll 24 is equivalent to a transport performance of the guide member 160 according to the comparative embodiment. In other words, the transport performance of the guide member 60 is maintained.

### Outline

As described above, in the transport unit 14, the facing edge 66a that faces the transport region R1, among the edges 66 on the transport roll 24 side, is recessed to be separated from the transport roll 24 compared to the side edges 66b arranged respectively on both sides of the facing edge 66a. In addition, the side edges 66b of the guide member 60 overlap the edge 166 of the guide member 160. For this reason, the transport unit 14 maintains the transport performance of the sheet member P, and generation of rising sound in a case where the trailing end of the sheet member P passes through the facing edge 66a of the guide member 60 is suppressed, compared to the transport unit 114 according to the comparative embodiment.

In addition, in the transport unit 14, the facing edge 66a extends linearly along the axial direction of the transport roll 24. In other words, the facing edge 66a extends linearly in the apparatus depth direction. For this reason, compared to a case where a maximum separation distance between the transport roll 24 and the facing edge is identical as in the present disclosure and the facing edge is inclined with respect to the apparatus depth direction, generation of rising sound in a case where the trailing end of the sheet member P passes through the facing edge 66a of the guide member 60 is suppressed. In other words, compared to a case where the recessed portion has a triangular shape, generation of rising sound in a case where the trailing end of the sheet member P passes through the facing edge 66a of the guide member 60 is suppressed.

In addition, in the transport unit 14, the connecting edge 66d that connects the facing edge 66a and the side edge 66b to each other is inclined with respect to the sheet transport direction such that the opening width (R2 of FIG. 4) of the recessed portion 66c is wider than the facing edge 66a in the apparatus depth direction. For this reason, compared to a case where the connecting edge extends in the sheet transport direction, damage to the sheet member P transported while coming into contact with a corner portion formed by the side edge 66b and the connecting edge 66d is suppressed.

In addition, in the transport unit 14, the separation distance L1 between the one side edge 66b and the other side edge 66b is shorter than the width of the sheet member Pm having a minimum size that can be transported by the transport unit 14. Accordingly, compared to a case where a separation distance between one edge and the other edge is longer than the width of the sheet member Pm having a minimum size that may be transported by the transport unit 14, the sheet member P having a minimum size is transported in a stable posture.

In addition, in the transport unit 14, at least some ribs 64 are formed in the range (H1 in FIG. 4) where the side edges 66b at the portions through which the sheet member P having a minimum size passes are arranged in the apparatus depth direction. Accordingly, compared to a case where the ribs are not formed on the guide surface, a decrease in the transport performance with respect to the sheet member P having a minimum size, of which a corner portion is curled, is suppressed.

In addition, compared to a case where the image forming apparatus 10 includes the transport unit 114 according to the comparative embodiment, abnormal noise in a case of image forming is suppressed.

Although details of a certain exemplary embodiment of the present disclosure have been described in detail, the present disclosure is not limited to such an exemplary embodiment, and it is clear for those skilled in the art that the present disclosure can take other various exemplary embodiments within the scope of the present disclosure. For example, although the guide member 60 is arranged on the downstream side in the sheet transport direction with respect to the prevention roll 22 in the exemplary embodiment, the guide member 60 may be arranged anywhere insofar as the guide member 60 is arranged at a place where the transport direction of the sheet member P can be changed.

In addition, although the transport roll 24 is a drive roll to which a drive force is transmitted in the exemplary embodiment, the transport roll 24 may be a driven roll.

In addition, although the facing edge 66a extends linearly in the apparatus depth direction in the exemplary embodiment, the facing edge may be inclined with respect to the apparatus depth direction. However, in this case, an action achieved by making the facing edge linear is not achieved.

In addition, although the connecting edges 66d are inclined with respect to the sheet transport direction such that the opening width of the recessed portion 66c is wider than the facing edge 66a in the apparatus depth direction in the exemplary embodiment, the connecting edges may not be inclined with respect to the sheet transport direction such that the opening width of the recessed portion is wider than the facing edge 66a in the apparatus depth direction. However, in this case, an action achieved by inclining the connecting edges 66d with respect to the sheet transport direction such that the opening width of the recessed portion 66c is wider than the facing edge 66a in the apparatus depth direction is not achieved.

In addition, although the separation distance L1 between the one side edge 66b and the other side edge 66b is shorter than the width of the sheet member Pm having a minimum size in the exemplary embodiment, the separation distance L1 may be longer than the width of the sheet member Pm. However, in this case, an action achieved by making the separation distance L1 shorter than the width of the sheet member Pm is not achieved.

(((1)))

A transport device comprising:
a transport roll that rotates and that transports a recording medium by pinching the recording medium in a transport region from one end to the other end in an axial direction; and
a guide member that guides a leading end of the recording medium to the transport roll by coming into contact with the recording medium while bending the recording medium and that is recessed such that a facing edge facing the transport region, among edges on a transport roll side, is separated from the transport roll compared to side edges arranged respectively on both sides of the facing edge.
   (((2)))

The transport device according to (((1))),
wherein the facing edge extends linearly along the axial direction.
   (((3)))

The transport device according to (((2))),
wherein a connecting edge that connects the facing edge and the side edges to each other, among the edges, is inclined with respect to a transport direction of the recording medium by making an opening width of a recessed portion formed by separating the facing edge from the transport roll compared to the side edges wider than the facing edge in the axial direction.
   (((4)))

The transport device according to any one of (((1))) to (((3))),
wherein a separation distance between one side edge and the other side edge is shorter than a width of a recording medium having a minimum size.
   (((5)))

The transport device according to (((4))),
wherein the guide member has a guide surface that guides the recording medium and that has a bent shape and a plurality of ribs that protrude from the guide surface to extend in a transport direction of the recording medium and that are provided at an interval in the axial direction, and
at least some of the ribs are formed in a range where a side edge at a portion through which the recording medium having the minimum size passes is arranged in the axial direction.
   (((6)))

An image forming apparatus comprising:
the transport device according to any one of ((1))) to (((5))) that transports a recording medium; and
an image forming unit that forms an image on the recording medium transported by the transport device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transport device comprising:
a transport roll that rotates and that transports a recording medium by pinching the recording medium in a transport region from one end to the other end in an axial direction; and
a guide member that guides a leading end of the recording medium to the transport roll by coming into contact with the recording medium while bending the recording medium and that is recessed such that a facing edge facing the transport region, among edges on a transport roll side, is separated from the transport roll compared to side edges arranged respectively on both sides of the facing edge.

2. The transport device according to claim 1,
wherein the facing edge extends linearly along the axial direction.

3. The transport device according to claim 2,
wherein a connecting edge that connects the facing edge and the side edges to each other, among the edges, is inclined with respect to a transport direction of the recording medium by making an opening width of a recessed portion formed by separating the facing edge from the transport roll compared to the side edges wider than the facing edge in the axial direction.

4. The transport device according to claim 1,
wherein a separation distance between one side edge and the other side edge is shorter than a width of a recording medium having a minimum size.

5. The transport device according to claim 4,
wherein the guide member has a guide surface that guides the recording medium and that has a bent shape and a plurality of ribs that protrude from the guide surface to extend in a transport direction of the recording medium and that are provided at an interval in the axial direction, and
at least some of the ribs are formed in a range where a side edge at a portion through which the recording medium having the minimum size passes is arranged in the axial direction.

6. An image forming apparatus comprising:
the transport device according to claim 1 that transports a recording medium; and
an image forming unit that forms an image on the recording medium transported by the transport device.

7. An image forming apparatus comprising:
the transport device according to claim 2 that transports a recording medium; and
an image forming unit that forms an image on the recording medium transported by the transport device.

8. An image forming apparatus comprising:
the transport device according to claim 3 that transports a recording medium; and
an image forming unit that forms an image on the recording medium transported by the transport device.

9. An image forming apparatus comprising:
the transport device according to claim 4 that transports a recording medium; and
an image forming unit that forms an image on the recording medium transported by the transport device.

10. An image forming apparatus comprising:
the transport device according to claim 5 that transports a recording medium; and
an image forming unit that forms an image on the recording medium transported by the transport device.
